(19) United States
(12) Patent Application Publication
(10) Pub. No.: US 2020/0142556 A1
(43) Pub. Date: May 7, 2020

(54) EQUIPMENT CHECKING SYSTEM AND DEVICE HAVING THE SAME

(71) Applicants: Avary Holding (Shenzhen) Co., Limited., Shenzhen (CN); HongQiSheng Precision Electronics (QinHuangDao) Co.,Ltd., Qinhuangdao (CN)

(72) Inventors: CHI-MING LIN, New Taipei (TW); CHI-YUAN CHANG, New Taipei (TW); SHU-BING HU, Shenzhen (CN)

(21) Appl. No.: 16/232,769

(22) Filed: Dec. 26, 2018

(30) Foreign Application Priority Data
Nov. 5, 2018 (CN) 201811309518.8

(51) Int. Cl. G06F 3/0484; G06F 3/0482; G06F 3/0488; G06F 3/0481; G06F 3/147

(52) U.S. Cl. CPC G06F 3/0484; G06F 3/0482; G06F 3/147; G06F 3/04817; G06F 3/04886

(57) ABSTRACT

A device for checking aspects of equipment includes a display screen, a memory, a processor, and an equipment checking system in a computer. The system includes a control unit and a checklist generating unit. The display screen can display a checking interface of an equipment. The checking interface includes item information of items for checking corresponding to the equipment, a data inputting area, and first and second confirmation icons. Data arising from inspections and checks can be input into the data inputting area. The checklist generating unit generates a checklist of all items for checking and checks carried out in response to an operation on the first confirmation icon. The checklist includes information as to an equipment, data as to checks required, and data as to results of checks carried out.

### FIELD

The subject matter herein generally relates to an equipment checking system.

### BACKGROUND

Manufacturing equipment which produce work pieces are often manually checked by workers. The worker records results of check of the manufacturing equipments on paper and manually inputs the results into a system. If the checking result are carried out twice, an error rate of results input into the system is likely to be increased.

Therefore, there is room for improvement within the art.

### BRIEF DESCRIPTION OF THE DRAWING

Implementations of the present technology will now be described, by way of example only, with reference to the attached FIG. 1.

FIG. 1 is a schematic diagram of an equipment checking device according to an exemplary embodiment.

### DETAILED DESCRIPTION

It will be appreciated that for simplicity and clarity of illustration, where appropriate, reference numerals have been repeated among the different FIGURES to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The disclosure is illustrated by way of example and not by way of limitation in the accompanying FIGURE. It should be noted that references to “an” or “one” embodiment in this disclosure are not necessarily to the same embodiment, and such references mean “at least one.”

The term “comprising,” when utilized, means “including, but not necessarily limited to”; it specifically indicates open-ended inclusion or membership in the so-described combination, group, series, and the like.

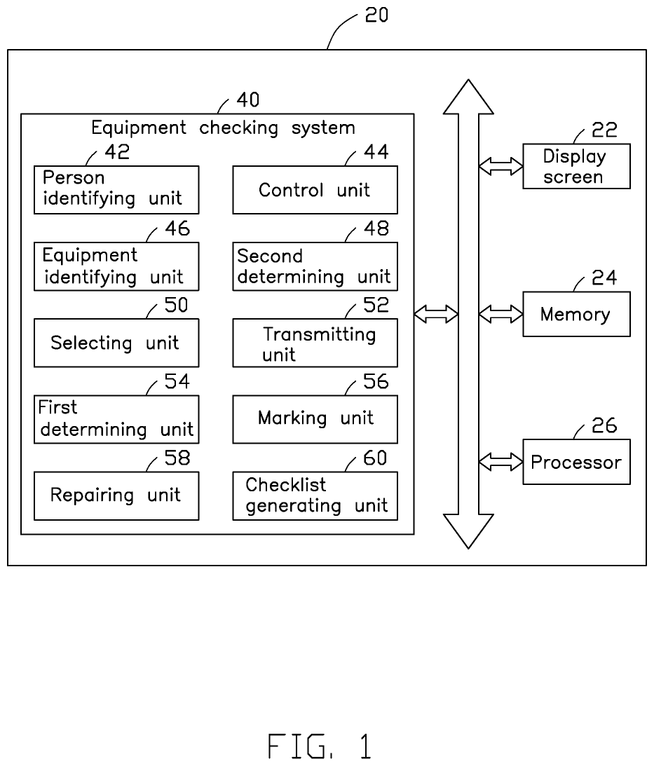

FIG. 1 shows, an equipment checking device 20 according to the present invention. The equipment checking device 20 includes a display screen 22, a memory 24, a processor 26, and an equipment checking system 40. The equipment checking device 20 can be a portable electronic device, such as a tablet personal computer. The memory 24 stores the equipment checking system 40. The equipment checking system 40 is configured to record data as to equipment. The equipment checking system 40 includes a person identifying unit 42, a control unit 44, an equipment identifying unit 46, a first determining unit 54, a second determining unit 48, a selecting unit 50, a transmitting unit 52, a marking unit 56, a repairing unit 58, and a checklist generating unit 60. The processor 26 is configured to execute the equipment checking system 40.

The person identifying unit 42 is configured to check identity of a checker when a checker identity tag approaches the equipment checking device 20. The checker identity tag can be a near field communication (NFC) electronic tag. The person identifying unit 42 identifies the checker having the checker identity tag by an NFC identification card having an NFC recognition function.

The control unit 44 is configured to control the display screen 22 to display the checker identity and information as to equipment authorized and required to be checked by the checker. The checker identity includes a name of the checker and a job number of the checker.

The equipment identifying unit 46 is configured to identify an equipment information of an equipment identity tag corresponding to an equipment when approaching the equipment checking device 20. The equipment identifying unit 46 is further configured to record time information when the equipment information is identified. The equipment identity tag can be an NFC electronic tag. The equipment identifying unit 46 identifies the equipment according to an NFC recognition function. In an embodiment, the equipment identifying unit 46 and the person identifying unit 42 can read a single NFC identification card.

The second determining unit 48 is configured to determine whether the checker is authorized to check the equipment according to a relationship between authorized equipment and checkers. When the checker is authorized, the control unit 44 controls the display screen 22 to display the equipment information of the equipment and the time information. The equipment information includes a name of the equipment and a location of the equipment.

In the embodiment, the equipment has a number of checkable states. The control unit 44 further controls the display screen 22 to display the checkable states, such as in course of normal production, weekly maintenance, and shutdown. The selecting unit 50 is configured to determine the checkable state selected by the checker according to an operation on the display screen 22. Checking items corresponding to different checkable states are different. The control unit 44 is further configured to control the display screen 22 to display a checking interface corresponding to a selected checkable state of the equipment. The checking interface includes the checking items corresponding to the selected checkable state. For example, when the checkable state is in course of normal production, the checking item includes all items relevant to the equipment. When the checkable state is weekly maintenance, the checking items includes the items requiring to be weekly checked. When the checkable state is the shutdown, the checking item is just one, and the transmitting unit 52 transmits a shutdown state of the equipment to a checking data system as the sole checking item.

The equipment can have a number of checking items corresponding to one of the checkable states. The selecting unit 50 is further configured to confirm the checking item selected by the checker according to an operation on the checking interface. The control unit 44 is further configured to display item information of selected checking item on the checking interface. The item information includes checking criteria of the checking item. The checking interface further includes a data inputting area for the checking. The checking data inputting area is used to input a checking data acquired by the checker when the checkable item of the equipment is checked. In an embodiment, the checking data is input through a virtual keyboard displayed on the checking interface. In another embodiment, the checking data is input by selecting from multiple choices in a selection box displayed on the checking interface.

The first determining unit 54 is configured to determine whether the checking data meets the checking criteria of the checking item. When the checking data does not meet the criteria of the checking item, the marking unit 56 marks the checking data to prompt the checker that the checking item is not to pass. The checking data can be marked in red.

The checking interface further includes a data adjusting area. The data adjusting area is used to input data of the checking item when a worker repairs the equipment to bring the checking item to a pass-through condition according to the checking criteria. The adjusting data can be input through a virtual keyboard displayed on the checking interface.

The person identifying unit 42 is further configured to identify a manager identity tag corresponding to management personnel when a manager identity tag approaches the equipment checking device 20. The checking interface further includes a repairing icon. The repairing icon only responds to an operation by a manager after a manager is identified. When the checking item of the equipment needs to delay before repair, the manager can operate the repairing icon to give notice that the equipment needs to be repaired or modified. The repairing unit 58 transmits the equipment information corresponding to the checking item and the checking data to a check-fail or non-pass list in response to an operation on the repairing icon.

The checking interface further includes a first confirmation icon. After checking all the checking items of the equipment corresponding to the selected checkable state, in response to an operation of the checker on the first confirmation icon, the checklist generating unit 60 generates a checklist of all the items checked. The checklist includes the checker, the equipment information, the time information, the item information of the checking item, the checking data, and the data as to adjustments or repairs done. The control unit 44 further controls the display screen 22 to display the checklist and a second confirmation icon. When the checklist is displayed on the display screen 22 and the person identifying unit 42 identifies the manager, the transmitting unit 52 transmits the checklist to the checking data system in response to an operation of the manager on the second confirmation icon.

In an embodiment, when one checking item in the checklist is selected, the control unit 44 controls the display screen 22 to display the checking interface of the checking item, so as to view the checking item. The control unit 44 further controls the display screen 22 to display an icon of rejection when the display screen 22 displays the checklist. The control unit 44 is further configured to reject the checklist in response to an operation of the manager on the rejecting icon, so that the checker rechecks or reconfirms at least one of the checking items.

Even though information and advantages of the present embodiments have been set forth in the foregoing description, together with details of the structures and functions of the present embodiments, the disclosure is illustrative only. Changes may be made in detail, especially in matters of shape, size, and arrangement of parts within the principles of the present embodiments to the full extent indicated by the plain meaning of the terms in which the appended claims are expressed.

What is claimed is:

1. An equipment checking system executed to:
control a display screen to display a checking interface of an equipment, the checking interface comprising item information of at least one checking item corresponding to the equipment, a checking data inputting area and a first confirmation icon, the checking data inputting area configured to input a checking data which is acquired when the checking item of the equipment is checked; and
generate a checklist of all the checking item having been checked in response to an operation on the first confirmation icon, the checklist comprising an equipment information of the equipment and the checking data of the checking item.

2. The equipment checking system of claim 1, wherein the equipment checking system is further executed to identify the equipment information of the equipment according to an equipment identity tag corresponding to the equipment approached an equipment checking device and record time information when the equipment information is identified, the item information is corresponding to the checking item of the equipment identified, the checklist comprises the time information.

3. The equipment checking system of claim 2, wherein the equipment has a plurality of checking states, checking items corresponding to different checking states are different, the equipment checking system is further executed to control the display screen to display the checking states and control the display screen to display the checking interface of the equipment corresponding to one of the checking states selected.

4. The equipment checking system of claim 3, wherein the checking interface comprises a plurality of checking items corresponding to selected checking state, the equipment checking system is further executed to display the item information of the checking item selected on the checking interface.

5. The equipment checking system of claim 1, wherein the checking interface further comprises a checking criterion of the checking item, the equipment checking system is further executed to determine whether the checking data meets the checking criterion of the checking item and mark the checking data when the checking data does not meet the checking criterion of the checking item.

6. The equipment checking system of claim 5, wherein the checking interface further comprises a data adjusting area, the data adjusting area is configured to input an adjusting data of the checking item when a worker repairs the equipment to make the checking item to be qualified according to the checking criterion of the checking item, the checklist further comprises the adjusting data.

7. The equipment checking system of claim 1, wherein the equipment checking system is further executed to identify an checker information of a checker identity tag corresponding to a checker when the checker identity tag approaches an equipment checking device, control the display screen to display the checker information of the checker and equipment information authorized to be checked by the checker, and control the display screen to display the item information of the checking item corresponding to the equipment according to the equipment information selected, the checking list further comprises the checker information.

8. The equipment checking system of claim 7, wherein the equipment checking system is further executed to identify an identity information of a manager according to a manager identity tag approaches the equipment checking device, control the display screen to display a second confirmation icon, and when the checklist is displayed on the display screen and the manager is identified, transmit the checklist to a checking data system in response to an operation of the manager on the second confirmation icon.

9. The equipment checking system of claim 8, wherein the checking interface further comprises a repairing icon, the equipment checking system is further executed to transmit the equipment information corresponding to the checking item and the checking data to a checking fail system in response to an operation on the repairing icon.

10. The equipment checking system of claim 8, wherein the equipment checking system is further executed to control the display screen to display a rejecting icon when the display screen displays the checklist, and reject the checklist in response to an operation of the manager on the rejecting icon.

11. An equipment checking device comprising:
a memory that stores one or more programs; and
a processor, wherein the one or more programs, when executed by the processor, cause the processor to:
control a display screen to display a checking interface of an equipment, the checking interface comprising item information of at least one checking item corresponding to the equipment, a checking data inputting area and a first confirmation icon, the checking data inputting area configured to input a checking data which is acquired when the checking item of the equipment is checked; and
generate a checklist of all the checking item having been checked in response to an operation on the first confirmation icon, the checklist comprising an equipment information of the equipment and the checking data of the checking item.

12. The equipment checking system of claim 11, wherein the processor is further caused to identify the equipment information of the equipment according to an equipment identity tag corresponding to the equipment approached an equipment checking device and record time information when the equipment information is identified, the item information is corresponding to the checking item of the equipment identified, the checklist comprises the time information.

13. The equipment checking system of claim 12, wherein the equipment has a plurality of checking states, checking items corresponding to different checking states are different, the processor is further caused to control the display screen to display the checking states and control the display screen to display the checking interface of the equipment corresponding to one of the checking states selected.

14. The equipment checking system of claim 13, wherein the checking interface comprises a plurality of checking items corresponding to selected checking state, the processor is further caused to display the item information of the checking item selected on the checking interface.

15. The equipment checking system of claim 11, wherein the checking interface further comprises a checking criterion of the checking item, the processor is further caused to determine whether the checking data meets the checking criterion of the checking item and mark the checking data when the checking data does not meet the checking criterion of the checking item.

16. The equipment checking system of claim 15, wherein the checking interface further comprises a data adjusting area, the data adjusting area is configured to input an adjusting data of the checking item when a worker repairs the equipment to make the checking item to be qualified according to the checking criterion of the checking item, the checklist further comprises the adjusting data.

17. The equipment checking device of claim 11, wherein the processor is further caused to identify an checker information of a checker identity tag corresponding to a checker when the checker identity tag approaches an equipment checking device, control the display screen to display the checker information of the checker and equipment information authorized to be checked by the checker, and control the display screen to display the item information of the checking item corresponding to the equipment according to the equipment information selected, the checking list further comprises the checker information.

18. The equipment checking device of claim 17, wherein the processor is further caused to identify an identity information of a manager according to a manager identity tag approaches the equipment checking device, control the display screen to display a second confirmation icon, and when the checklist is displayed on the display screen and the manager is identified, transmit the checklist to a checking data system in response to an operation of the manager on the second confirmation icon.

19. The equipment checking device of claim 18, wherein the checking interface further comprises a repairing icon, the processor is further caused to transmit the equipment information corresponding to the checking item and the checking data to a checking fail system in response to an operation on the repairing icon.

20. The equipment checking device of claim 18, wherein the processor is further caused to control the display screen to display a rejecting icon when the display screen displays the checklist, and reject the checklist in response to an operation of the manager on the rejecting icon.
